(19) United States
(12) Patent Application Publication
(10) Pub. No.: US 2005/0201205 A1
(43) Pub. Date: Sep. 15, 2005

(54) Acoustic transducer assembly for aluminum hulled vessels

(76) Inventors: Alfred Max Chavez, Pedly, CA (US); Richard Anthony Chavez, La Mesa, CA (US)

Correspondence Address: ALTERA LAW GROUP, LLC, 6500 CITY WEST PARKWAY, SUITE 100, MINNEAPOLIS, MN, 55344-7704, US

(21) Appl. No.: 10/798,797

(22) Filed: Mar. 10, 2004

(51) Int. Cl. G01S 15/00

(52) U.S. Cl. 367/152

(57) ABSTRACT

A transducer assembly is provided with an ultrasonic transducer, a capacitor, and a transformer enclosed within a protective housing, and an acoustic block. The transducer is adhered to the acoustic block, and the materials of the transducer, acoustic block, and adhesive are selected so that when the transducer assembly is adhered to an aluminum boat hull, acoustic energy loss due to attenuation is mitigated. The secondary winding of the transformer and the capacitor form a resonant circuit that is wired to the ultrasonic transducer and helps to reject some of the acoustic-generated hull noise that may reach the transducer. The transformer steps up the voltage pulses to the transducer. In use, the transducer assembly is wired to a sounding unit, which provides the voltage pulses for generating ultrasonic pulses, and processes electrical signals from the transducer that correspond to ultrasonic echoes.

### BACKGROUND OF THE INVENTION

1. Field of the Invention

The present invention relates to acoustic transducer assemblies, and in particular to acoustic transducer assemblies for aluminum-hulled watercraft.

2. Description of the Related Art

Sonar technology using signals generated by ultrasonic transducers has been used for some time in connection with both the commercial and recreational marine industry to locate and determine the size of marine life. Sonar transducers used for these purposes may be mounted on the outside of a boat's hull, in a hole cut into a boat's hull, or on the interior of a boat's hull. Alternatively, sonar transducers may be mounted separately from the hull via a bracket or other connecting structure such as a motor mount.

Sonar transducers that are mounted on the exterior of a boat's hull and exposed to the water may become damaged by their extensive exposure to the water and other environmental elements. Such transducers could also be damaged by traumatic contact with the water's bottom or foreign objects. Moreover, mounting a transducer on the exterior of a boat hull compromises the boat hull. This is especially problematic with aluminum-hulled boats, since aluminum-hulled boats are manufactured with specific protective conversion coatings applied to the exterior of the hull. Drilling holes into the exterior of the hull to externally mount a transducer removes this protective coating, thereby exposing an area for corrosion to begin, or, if there is a mismatch of materials, a galvanic reaction resulting in a premature failure of the base material of the hull.

The aforementioned problems with environmental damage and decay, corrosion, and failure of the base material are not normally a problem in an ultrasonic transducer that is mounted on the interior surface of the hull. Such transducers are typically enclosed within a housing, and the housing is attached to the interior of the hull.

While mounting an ultrasonic transducer on the interior of a hull virtually eliminates the risk of damage to the unit due to environmental factors, and has been successfully done on fiberglass hulls, serious problems arise when interior-hull mounting is attempted with aluminum hulls. For example, unacceptable attenuation of the ultrasonic signal between the transducer and the water is experienced. Moreover, hull noise is a serious problem with aluminum-hulled boats.

The art is therefore in need of an ultrasonic transducer that can be easily mounted on the interior of, and effectively used in connection with, aluminum-hulled boats.

### BRIEF SUMMARY OF THE INVENTION

Advantageously for one or more embodiments of the present invention, an improved ultrasonic transducer assembly and mounting system are provided for the interior of an aluminum boat hull. In one embodiment, the ultrasonic transducer assembly includes a resonant circuit to improve rejection of acoustic noise. In another embodiment, the ultrasonic transducer assembly includes a transformer to eliminate the need for external matching circuits. In another embodiment, the ultrasonic transducer assembly includes materials selected to reduce acoustic losses between the face of the transducer and an aluminum hull.

Advantageously, a transducer assembly in accordance with one or more embodiments of the present invention is compact and easy to mount on the interior of an aluminum hull with one or more suitable adhesives. In one embodiment, an adhesive is applied to the transducer face, and an acoustic block of suitable material is applied to the transducer face. To mount the transducer assembly, an adhesive is also applied to an opposite side of the acoustic block, and the transducer assembly and acoustic block are mounted on the interior of an aluminum boat hull. The mounting can occur during or after manufacture of the aluminum boat hull.

One embodiment of the present invention is an ultrasonic transducer assembly comprising a housing, an ultrasonic transducer, and an acoustic block. The ultrasonic transducer is disposed within an interior of the housing and has an active surface directed away from the housing interior. The acoustic block is disposed in proximity to the active surface of the ultrasonic transducer. The ultrasonic transducer and the acoustic block have respective acoustic impedance characteristics that mitigate acoustic losses between the transducer and an aluminum watercraft hull.

Another embodiment of the present invention is an ultrasonic transducer assembly for mounting on an interior surface of an aluminum-hulled boat, comprising a housing, an ultrasonic transducer, an inductor, and a capacitor. The ultrasonic transducer is disposed within an interior of the housing and has an active surface directed away from the housing interior. The inductor and the capacitor are disposed within the housing interior, and are coupled to form a resonant circuit and are further coupled to the ultrasonic transducer.

A further embodiment of the present invention is an ultrasonic transducer assembly for mounting on an interior surface of an aluminum-hulled boat, comprising a housing, an ultrasonic transducer, and a transformer. The ultrasonic transducer is disposed within an interior of the housing and has an active surface directed away from the housing interior. The transformer is disposed within the interior of the housing and has a first winding for being coupled to a sounding unit external to the housing, and a second winding coupled to the ultrasonic transducer.

Yet another embodiment of the present invention is a manufacture for use in a watercraft, comprising an aluminum watercraft hull having an interior surface; a transducer assembly, and a second adhesive layer. The transducer assembly comprises a housing; an ultrasonic transducer disposed within an interior of the housing and having an active surface directed away from the housing interior; a transformer disposed within the interior of the housing and having a first winding for being coupled to a sounding unit external to the housing, and a second winding coupled to the ultrasonic transducer; a capacitor disposed within the interior of housing and coupled to the second winding, the capacitor and the second winding forming a resonant circuit; an acoustic block disposed in proximity to the active surface of the ultrasonic transducer; and a first adhesive layer disposed between a first surface of the acoustic block and the active surface of the ultrasonic transducer. The second adhesive layer is disposed between a second surface of the acoustic block and the interior surface of the aluminum hull, and the ultrasonic transducer, the first adhesive layer, the acoustic block, and the second adhesive layer have respective acoustic impedance characteristics that mitigate acoustic losses between the transducer and the aluminum watercraft hull.

A further embodiment of the present invention is a method to detect an object in a body of water beneath an aluminum-hulled watercraft using a sounding unit, comprising generating a first voltage pulse at a selected frequency at the sounding unit; supplying the first voltage pulse to a sealed ultrasonic transducer assembly; stepping up the first voltage pulse to a second voltage pulse in the transducer assembly; supplying the second voltage pulse to an ultrasonic transducer in the transducer assembly to generate an ultrasonic acoustic signal; and transmitting the ultrasonic acoustic signal into the body of water through an impedance-matching acoustic block and through the aluminum hull.

Yet another embodiment of the present invention is a method of manufacturing an aluminum hull for use in a watercraft, comprising providing a sealed transducer assembly comprising an ultrasonic transducer with an active surface; attaching the transducer assembly to an acoustic block with a first layer of adhesive disposed between the active surface and a first surface of the acoustic block; and attaching a second surface of the acoustic block to the aluminum hull with a second layer of adhesive disposed between the second surface of the acoustic block and the aluminum hull.

### BRIEF DESCRIPTION OF THE SEVERAL VIEWS OF THE DRAWINGS

FIG. 1 is a cross section diagram showing an embodiment of a transducer assembly in accordance with the present invention.

FIG. 2 is a schematic diagram of a circuit useful in the transducer assembly of FIG. 1.

### DETAILED DESCRIPTION OF THE INVENTION, INCLUDING THE BEST MODE

A transducer assembly is provided with an ultrasonic transducer, a capacitor, a transformer, and an acoustic block. The transformer provides impedance matching of the transducer to a sounding unit, which supplies electrical drive signals to the transducer for transmitting ultrasonic pulses, and processes electrical signals from the transducer that correspond to ultrasonic echoes received by the transducer. The secondary winding of the transformer and the capacitor form a resonant circuit that is electrically connected to the transducer. The resonant circuit helps to reject some of the acoustic-generated hull noise that may reach the transducer. It will be appreciated that other types of circuits well known in the art may be used inside the transducer assembly to help in the rejection of hull noise. The transducer assembly further includes an acoustic block, to which the ultrasonic transducer is adhered. The materials of the transducer, acoustic block, and adhesive are selected so that when the transducer assembly is adhered to an aluminum boat hull, excessive acoustic energy loss due to attenuation is avoided. Aluminum boat hulls typically have a thickness in the range of 0.06 to 0.125 inches, and may include materials in addition to pure aluminum, such as alloys, oxides, and protective coatings, as is well known in the art. The transducer, transformer and capacitor are enclosed within a protective housing, along with other materials to further insulate the transducer from acoustic-generated hull noise.

In operation, the sounding unit supplies a series of ultrasonic pulses to the transformer, which steps up the voltage of the pulses and provides the stepped up voltage to the transducer to enable the transducer to efficiently produce an acoustic signal at the points of contact between the transducer face, the acoustic block, and the aluminum boat hull. The electrical impedance matching, in combination with the acoustic impedance matching of the transducer, acoustic block and aluminum hull, allows for a higher level of acoustic energy to be transmitted through the hull and into the water, and to be received through the hull from the water. Electrical and acoustic loses are mitigated.

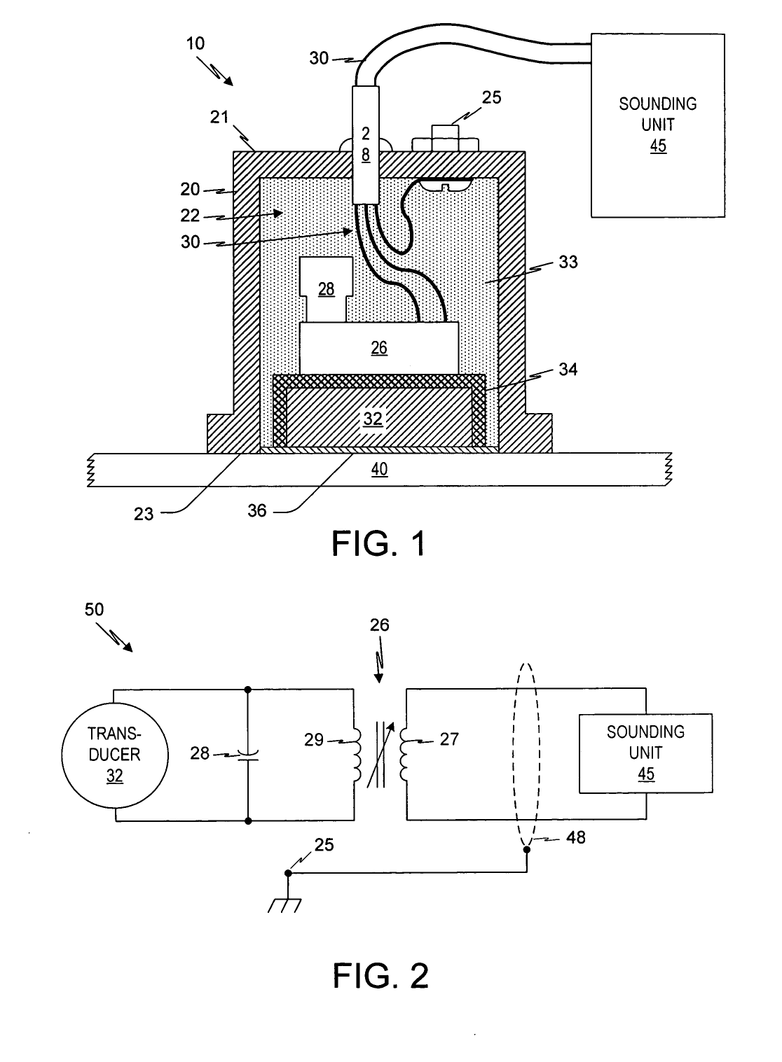

An embodiment of a transducer assembly 10 in accordance with the present invention is illustrated in FIG. 1.

The transducer assembly 10 has an outer housing 20 that can be manufactured out of a number of materials including plastic. The housing 20 has an interior chamber 22. Chamber 22 is filled with one or more epoxies 33 along with other components of the transducer assembly 10 as is further described below. A conduit 28 penetrates the housing 20 at proximate end 21 and enters chamber 22. The conduit 28 provides a passageway for wires 30 into the chamber 22. Alternatively, an electrical cable or an electrical connector may be used. The wires 30 connect a sounding unit 45 to the primary winding of a transformer 26 located in the chamber 22. A ground stud 25 attached to proximate end 21 of housing 20 provides a ground connector for the transducer assembly 10. A capacitor 28 is wired to the secondary winding of the transformer 26, and the capacitor 28 and the transformer 26 are in turn wired to an ultrasonic transducer 32. While any of a variety of different types of ultrasonic transducers may be used, preferably the ultrasonic transducer 32 is a ceramic piezoelectric transducer such as part number 4648, available from Channel Industries of Santa Barbara, Calif. 93111. Except for an active surface from which ultrasonic energy is transmitted, the transducer 32 preferably is enclosed by a wrapping 34, which may be cork or cork-like material or any other suitable material. Distal end 23 of the housing 20 is defined by an acoustic block 36, which is placed against the transducer 32. The acoustic block 36 preferably is a thin phenolic, which is a laminated plastic composed of paper or glass cloth impregnated with synthetic resins. The phenolic preferably is approximately 0.012-0.036 of an inch thick. A suitable phenolic is Mycarta Part No. 254, manufactured by Myer Plastics, Inc. of Indianapolis, Ind. A suitable thickness is approximately 0.016 of an inch, although other thicknesses may be used if desired. Another suitable acoustic block would be a beryllium disc (made with an aluminum or copper base) of thickness similar to that of a phenolic.

FIG. 2 shows an illustrative circuit 50 suitable for use in the transducer assembly 10. The transformer 26 illustratively has a primary winding 27 of 55 turns of #26 AWG and a secondary winding 29 of 157 turns of #30 AWG. The capacitor 28 is connected in parallel with the secondary winding 29 of the transformer 26 as well as the transducer 32, and illustratively has a value of 331 pF. The circuit of FIG. 2 provides a resonant circuit substantially matched to the ultrasonic frequency of the pulses from the sounding unit 45, and functions to filter out interfering acoustic frequencies that might reach the transducer 32 from the hull, motor, and other such sources. Accordingly, the values of the transformer 26 and the capacitor 28 may be selected as needed to provide the desired filtering. Alternatively, other types of filtering circuits may be used in either the primary or secondary circuits of the transformer, inside the transducer assembly 10.

The transducer assembly 10 is placed on the interior of an aluminum boat hull 40, either at the time of manufacture of a boat hull or thereafter by a watercraft manufacturer, distributor, vendor or consumer. An adhesive securely adheres the distal surface of the transducer 32 to one surface of the acoustic block 36. An adhesive also securely adheres the other surface of the acoustic block 36 to an interior surface of the boat hull 40. Preferably, the adhesive forms a continuous layer of about 1 mm or less. Illustratively, Epoweld® 8200 Epoxy, available from Harcros Chemical, Inc. of Belleville, N.J., is a suitable adhesive bonding agent. The Epoweld® 8200 Epoxy exhibits high coupling and strong adhesion to an aluminum boat hull, and is resistant to water, oil and gas. Other adhesives or combinations of adhesives having these characteristics are also suitable. Moreover, if desired different adhesives may be used between the transducer 32 and the acoustic block 36, and between the acoustic block 36 and the aluminum hull 40. The acoustic matching properties of the transducer assembly 10 may also be established by the use of multiple acoustic blocks having progressively different acoustic characteristics, if desired.

The transducer assembly 10 functions as follows. The sounding unit 45 generates and supplies voltage pulses to the transducer assembly 10 via wires 30, which may be electrically shielded by a cable shield 48. The sounding unit 45 can be any commercially available off the shelf unit that supplies a typical voltage level. The voltage is stepped up by the transformer 26, causing a higher voltage to be supplied to the transducer 32. This occurs where it is particularly useful, namely at the area of contact between the transducer 32, the acoustic block 36, and the boat hull 40. The acoustic signal produced by the transducer is preferably in the 50 KHz to 200 KHz range. If desired, the transducer assembly 10 may be designed to operate at a frequency within a broader range, such as, for example, approximately 28 KHz to 455 KHz. The signal produced by the transducer 32 is transmitted through the aluminum boat hull 40 and into the water below. The reflection of the signal, whether it is off the water bottom, a school of fish, or some other formation or object, passes through the hull, and is received back at the transducer 32. The acoustic reflections are converted into electrical signals by the transducer 32, which are furnished to the sounding unit 45 for further processing, analysis and display.

The transducer assembly 10 of the present invention overcomes problems of excessive attenuation, acoustic-generated hull noise, and ringing. Attenuation is reduced by providing a proper electrical impedance match between the sounding unit 45 and the transducer 32 by use of the step-up transformer. Attenuation is further reduced by providing as good as possible acoustic impedance matching among the transducer 32, acoustic block 36, and aluminum hull 40. The acoustic block 36 improves the acoustic impedance match between the face of the transducer 32 and the boat hull 40. In effect, good electrical impedance matching preserves the strength of the drive and received signals, while good acoustic impedance matching produces an acoustically clear window between the transducer assembly 10 and the water, thereby allowing acoustic energy to be readily exchanged between the transducer 32 and the water through the aluminum hull 40. Consequently, the ultrasonic pulses and the echoes are more effectively transmitted through the boat hull. Cork or other suitable material is used as the wrapping 34 since it helps to direct a maximum of acoustic energy towards the acoustic block 36 and aluminum hull 40, and consequently further decreases signal attenuation.

The impedance matching of the transducer 32, acoustic block 36, and boat hull 40 also isolates the transducer assembly 10 from much of the interfering acoustic-generated hull noise. The adverse effects of acoustic-generated hull noise are further reduced by the cork wrapping 34, which further isolates the transducer from the acoustic-generated hull noise.

The potential problem of transducer ringing is minimized by the use of the cork wrapping 34, and filling the chamber 22 with an epoxy 33. The wrapping 34 and epoxy 33 isolate and stabilize the transducer, thereby preventing or minimizing ringing in the transducer. A preferred epoxy is Epon 828, which is a resin based epoxy available from the Epmar Corp. of Santa Fe Springs, Calif. 90670. Micro-balloons may be mixed into the epoxy so as to create air spaces within the epoxy to help reduce back scatter noise generated by the excitement of the piezoelectric transducer during the transmission of a pulse. If desired, various epoxies of different acoustic characteristics may be layered. While the chamber 22 is shown filled with epoxy 33, it may also be only partially filled with epoxy, or filled with epoxy and other materials. While a single chamber 22 is shown in FIG. 1, multiple chambers may be used if desired.

While the invention has been described in the preferred and other embodiments, it is to be understood that the embodiments are presented for the purpose of description rather than limitation, and that the embodiments may be changed and additional embodiments developed without departing from the scope and spirit of the invention as defined by the following claims.

1. An ultrasonic transducer assembly comprising:
a housing;
an ultrasonic transducer disposed within an interior of the housing and having an active surface directed away from the housing interior; and
an acoustic block disposed in proximity to the active surface of the ultrasonic transducer;
wherein the ultrasonic transducer and the acoustic block have respective acoustic impedance characteristics that mitigate acoustic losses between the transducer and an aluminum watercraft hull.

2. The ultrasonic transducer assembly of claim 1, further comprising a transformer disposed within the interior of the housing and having a first winding for being coupled to a circuit external to the housing, and a second winding coupled to the ultrasonic transducer.

3. The ultrasonic transducer assembly of claim 2, further comprising a capacitor disposed within the interior of housing and coupled in parallel to the second transformer winding.

4. The ultrasonic transducer assembly of claim 1, wherein the transformer steps up voltage to the ultrasonic transducer.

5. The ultrasonic transducer assembly of claim 1, further comprising:
a first adhesive layer disposed between the acoustic block and the active surface of the ultrasonic transducer;
wherein the first adhesive layer, the ultrasonic transducer, and the acoustic block have respective acoustic impedance characteristics that mitigate acoustic losses between the transducer and the aluminum hull.

6. The ultrasonic transducer assembly of claim 1, wherein the acoustic block comprises beryllium.

7. The ultrasonic transducer assembly of claim 1, wherein the acoustic block comprises a laminated plastic.

8. The ultrasonic transducer assembly of claim 7, wherein the laminated plastic comprises a phenolic.

9. The ultrasonic transducer assembly of claim 8, wherein the phenolic is of a thickness in the range of about 0.012 inches to about 0.036 inches.

10. The ultrasonic transducer assembly of claim 1, further comprising a wrapping effectively enclosing the ultrasonic transducer except for the active surface.

11. The ultrasonic transducer assembly of claim 10, wherein the wrapping comprises cork.

12. The ultrasonic transducer assembly of claim 3:
wherein the interior of the housing is filled with an epoxy; and
wherein the transformer, the capacitor, and the ultrasonic transducer are disposed in the epoxy within the interior of the housing.

13. The ultrasonic transducer assembly of claim 12 further comprising micro-balloons disposed in the epoxy.

14. The ultrasonic transducer assembly of claim 1, wherein the transducer is a ceramic piezoelectric transducer.

15. The ultrasonic transducer assembly of claim 1 further comprising:
an electrical conductor passing through the housing from the interior thereof for coupling to an external sounding unit; and
a resonant circuit disposed in the housing interior and electrically coupled between the electrical conductor and the ultrasonic transducer.

16. The ultrasonic transducer assembly of claim 1 further comprising:
an electrical impedance matching circuit disposed in the housing interior and electrically coupled between the electrical conductor and the ultrasonic transducer.

17. The ultrasonic transducer assembly of claim 1 further comprising:
an electrical conductor passing through the housing from the interior thereof for coupling to an external sounding unit; and
a resonant impedance matching circuit disposed in the housing interior and electrically coupled between the electrical conductor and the ultrasonic transducer.

18. An ultrasonic transducer assembly for mounting on an interior surface of an aluminum-hulled boat, comprising:
a housing;
an ultrasonic transducer disposed within an interior of the housing and having an active surface directed away from the housing interior;
an inductor disposed within the housing interior; and
a capacitor disposed within the housing interior;
wherein the inductor and the capacitor are coupled to form a resonant circuit and are coupled to the ultrasonic transducer.

19. The ultrasonic transducer assembly of claim 18:
further comprising a step-up transformer having a primary winding and a secondary winding, the inductor being the secondary winding;
wherein the ultrasonic transducer is a ceramic piezoelectric transducer.

20. The ultrasonic transducer assembly of claim 18, further comprising:
an acoustic block disposed in proximity to the active surface of the ultrasonic transducer; and
an adhesive layer disposed between the acoustic block and the active surface of the ultrasonic transducer;
wherein the ultrasonic transducer, the acoustic block, and the adhesive layer have respective acoustic impedance characteristics that mitigate acoustic losses between the ultrasonic transducer and an aluminum watercraft hull coated with an additional adhesive layer for adhering the ultrasonic transducer assembly to the aluminum watercraft hull.

21. An ultrasonic transducer assembly for mounting on an interior surface of an aluminum-hulled boat, comprising:
a housing;
an ultrasonic transducer disposed within an interior of the housing and having an active surface directed away from the housing interior; and
a transformer disposed within the interior of the housing and having a first winding for being coupled to a sounding unit external to the housing, and a second winding coupled to the ultrasonic transducer.

22. The ultrasonic transducer assembly of claim 21:
further comprising a capacitor disposed within the housing interior;
wherein the second winding of the transformer and the capacitor are coupled to form a resonant circuit and are further coupled to the ultrasonic transducer.

23. The ultrasonic transducer assembly of claim 22 wherein:
the transformer is a step-up transformer, the first winding being a primary winding and the second winding being a secondary winding; and
wherein the ultrasonic transducer is a ceramic piezoelectric transducer.

24. The ultrasonic transducer assembly of claim 21, further comprising:
an acoustic block disposed in proximity to the active surface of the ultrasonic transducer; and
an adhesive layer disposed between the acoustic block and the active surface of the ultrasonic transducer;
wherein the ultrasonic transducer, the acoustic block, and the adhesive layer have respective acoustic impedance characteristics that mitigate acoustic losses between the ultrasonic transducer and an aluminum watercraft hull coated with an additional adhesive layer for adhering the ultrasonic transducer assembly to the aluminum watercraft hull.

25. A manufacture for use in a watercraft, comprising:
an aluminum watercraft hull having an interior surface;
a transducer assembly comprising:
a housing;
an ultrasonic transducer disposed within an interior of the housing and having an active surface directed away from the housing interior;
a transformer disposed within the interior of the housing and having a first winding for being coupled to a sounding unit external to the housing, and a second winding coupled to the ultrasonic transducer;
a capacitor disposed within the interior of housing and coupled to the second winding, the capacitor and the second winding forming a resonant circuit;
an acoustic block disposed in proximity to the active surface of the ultrasonic transducer; and
a first adhesive layer disposed between a first surface of the acoustic block and the active surface of the ultrasonic transducer; and
a second adhesive layer disposed between a second surface of the acoustic block and the interior surface of the aluminum hull;
wherein the ultrasonic transducer, the first adhesive layer, the acoustic block, and the second adhesive layer have respective acoustic impedance characteristics that mitigate acoustic losses between the transducer and the aluminum watercraft hull.

26. The manufacture of claim 25, wherein the first adhesive layer is identical to the second adhesive layer.

27. The manufacture of claim 25, wherein the first adhesive layer is different than the second adhesive layer.

28. A method to detect an object in a body of water beneath an aluminum-hulled watercraft using a sounding unit, comprising:
generating a first voltage pulse at a selected frequency at the sounding unit;
supplying the first voltage pulse to a sealed ultrasonic transducer assembly;
stepping up the first voltage pulse to a second voltage pulse in the transducer assembly;
supplying the second voltage pulse to an ultrasonic transducer in the transducer assembly to generate an ultrasonic acoustic signal; and
transmitting the ultrasonic acoustic signal into the body of water through an impedance-matching acoustic block and through the aluminum hull.

29. The method of claim 28, further comprising:
generating a third voltage pulse at the ultrasonic transducer from the reflection of the ultrasonic acoustic signal from the object;
applying the third voltage pulse from the ultrasonic transducer to a resonant circuit in the transducer assembly to obtain a fourth voltage from which frequencies other than the selected frequency are rejected; and
furnishing the fourth voltage to the sounding unit.

30. The method of claim 29 wherein the selected frequency is in a range of about 28 KHz to about 455 KHz.

31. The method of claim 30 wherein the selected frequency is in a range of 50 KHz to 200 KHz.

32. A method of manufacturing an aluminum hull for use in a watercraft, comprising:
providing a sealed transducer assembly comprising an ultrasonic transducer with an active surface;
attaching the transducer assembly to an acoustic block with a first layer of adhesive disposed between the active surface and a first surface of the acoustic block; and
attaching a second surface of the acoustic block to the aluminum hull with a second layer of adhesive disposed between the second surface of the acoustic block and the aluminum hull.

33. The method of claim 32 wherein the sealed transducer assembly further comprises:
a voltage step-up functionality for transmitting an ultrasonic acoustic signal of a predetermined frequency; and
a frequency rejection functionality for rejecting signals in a received acoustic signal other than the predetermined frequency.
